(19) United States
(12) Patent Application Publication
(10) Pub. No.: US 2012/0236042 A1
(43) Pub. Date: Sep. 20, 2012

(54) WHITE POINT TUNING FOR A DISPLAY

(75) Inventors: Manu Parmar, Sunnyvale, CA (US); Koorosh Aflatooni, Cupertino, CA (US); William J. Cummings, Clinton, WA (US)

(73) Assignee: QUALCOMM MEMS TECHNOLOGIES, INC., San Diego, CA (US)

(21) Appl. No.: 13/216,026

(22) Filed: Aug. 23, 2011

Related U.S. Application Data
(60) Provisional application No. 61/453,031, filed on Mar. 15, 2011.

(51) Int. Cl. G09G 5/00

(52) U.S. Cl. 345/690

(57) ABSTRACT

This disclosure provides systems, methods and apparatus, including computer programs encoded on computer storage media, for tuning the white point of a display device. In one aspect, a display device includes a set of display elements configured to output light and electronics configured to drive the display elements. Each display element can have an on-state where a reflective surface can be positioned at a distance from a partially reflective surface such that the display element can reflect incident light. Each distance can be dependent on a bias voltage. At least one of the bias voltages for the display elements can be non-zero in the on-state, and one or more of the bias voltages may be adjustable to control a white point of the display device. The electronics can be electrically connected to the display elements to provide the at least one non-zero bias voltage.

### CROSS-REFERENCE TO RELATED APPLICATIONS

This disclosure claims priority to U.S. Provisional Patent Application No. 61/453,031, filed Mar. 15, 2011, entitled “WHITE POINT TUNING FOR A DISPLAY,” and assigned to the assignee hereof. The disclosure of the prior application is considered part of, and is incorporated by reference in, this disclosure.

### TECHNICAL FIELD

This disclosure relates to electromechanical systems and white point tuning of displays having such systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device. The display device can include a first display element configured to output light, a second display element configured to output light, and a third display element configured to output light. The display device further can include electronics configured to drive the first, second, and third display elements. Each of the first, second, and third display elements can have an on-state where a reflective surface can be positioned at a distance from a partially reflective surface such that the display element can reflect incident light. Each distance can be dependent on a bias voltage. At least one of the bias voltages for the first, second, and third display elements can be non-zero in the on-state, and adjustable to control a white point of the display device. The electronics can be electrically connected to the display elements to provide the at least one non-zero bias voltage. In some implementations, at least two of the bias voltages for the first, second, and third display elements are non-zero in the on-states. One, some, or all of the at least two bias voltages can be adjustable to control the white point of the display device. In some other implementations, the bias voltages for the first, second, and third display elements are non-zero in the on-states. One, some, or all of the three bias voltages can be adjustable to control the white point for the display device. In some implementations, the display device can include additional display elements having bias voltages that may be adjustable to control the white point of the display device.

In some implementations, the display elements can include interferometric modulators. The electronics can be configured to access a database that stores information correlating the white point and the bias voltages to establish the bias voltages. In some other implementations, the electronics can be configured to use a formula that correlates the white point and the bias voltages to establish the bias voltages. Some implementations further can include a user interface in communication with the electronics. The electronics can be configured to adjust the white point by adjusting the bias voltages for the first, second, and third display elements based on input from the user interface. The electronics can adjust the white point using a fixed relationship between the bias voltages for the first, second, and third display elements.

In some implementations, the white point can be adjusted by tuning at least one resonant wavelength of an optical resonant cavity defined by the reflective surface and the partially reflective surface of the display element by adjusting the distance between the reflective surface and the partially reflective surface. In some implementations, the first display element can include a red display element, the second display element can include a green display element, and the third display element can include a blue display element. The red display element can be configured to output red light when the red display element is in the on-state. The green display element can be configured to output green light when the green display element is in the on-state. The blue display element can include a blue display element configured to output blue light when the blue display element is in the on-state. In some implementations, the first, second, and third display elements can each include white display elements configured to output white light when the display elements are in the on-state.

In some implementations, the display device further can include a processor that is configured to communicate with at least one display element. The processor can be configured to process image data. The display device further can include a memory device that is configured to communicate with the processor. The display device further can include a driver circuit configured to send at least one signal to at least one display element. The display device further can include a controller configured to send at least a portion of the image data to the driver circuit. The display device further can include an image source module configured to send the image data to the processor. The image source module can include at least one of a receiver, transceiver, and transmitter. The display device further can include an input device configured to receive input data and to communicate the input data to the processor.

Another innovative aspect described in this disclosure can be implemented in a display device including a first means for outputting light, a second means for outputting light, a third means for outputting light and means for driving the first, second, and third light outputting means. Each of the first, second, and third light outputting means can have an on-state where a means for reflecting light can be positioned at a distance from a means for partially reflecting light such that the light outputting means can reflect incident light. Each distance can be dependent on a bias voltage. At least one of the bias voltages for the first, second, and third light outputting means can be non-zero in the on-state. The at least one bias voltage also can be adjustable to control a white point of the display device. The driving means can be electrically connected to the first, second, and third light outputting means to provide the at least one non-zero bias voltage. In some implementations, at least two of the bias voltages for the first, second, and third light outputting means are non-zero in the on-states. One, some, or all of the at least two bias voltages can be adjustable to control the white point of the display device. In some other implementations, the bias voltages for the first, second, and third light outputting means are non-zero in the on-states. One, some, or all of the three bias voltages can be adjustable to control the white point for the display device.

In some implementations of the display device, the first, second, and third, light outputting means can include first, second, and third interferometric modulators respectively. The driving means can include electronics, the light reflecting means can include a reflective surface, or the partial light reflecting means can include a partially reflective surface. The first light outputting means can include a red interferometric modulator, the second light outputting means can include a green interferometric modulator, and the third light outputting means can include a blue interferometric modulator. The red interferometric modulator can be configured to output red light. The green interferometric modulator can be configured to output green light. The blue interferometric modulator can be configured to output blue light. In some implementations, the first, second, and third light outputting means includes white interferometric modulators.

The driving means can be configured to establish the bias voltages based on a correlation between the white point and the bias voltages. In some implementations, the driving means can be configured to access a database to establish the bias voltages based on a correlation between the white point and the bias voltages. In some other implementations, the driving means can be configured to access a formula to establish the bias voltages based on a correlation between the white point and the bias voltages. The driving means can include a processor in communication with a computer-readable storage medium. The display device further can include means for receiving a selection of a white point. The receiving means can include a user interface.

Another innovative aspect described in this disclosure can be implemented in a method for setting a white point of a display device. The method can include selecting a white point for the display device. The display device can include a first, a second, and a third display element. Each display element can have an on-state where a reflective surface can be positioned at a distance from a partially reflective surface such that the display element can reflect incident light. Each distance can be dependent on a bias voltage. At least one of the bias voltages can be non-zero in the on-state. The at least one bias voltage also can be adjustable to control a white point of the display device. The method further can include using electronics electrically connected to the first, second, and third display elements to set the at least one non-zero bias voltage.

The first, second, and third, display elements can include red, green, and blue interferometric modulators, respectively. In some implementations of the method, using electronics can include accessing a database that stores information correlating white points with the bias voltages, and using the database to determine the corresponding bias voltages for the first, second, and third display elements. In some other implementations, using electronics can include accessing a formula that correlates white points with bias voltages, and using the formula to determine the corresponding bias voltages for the first, second, and third display elements. The method further can include holding an image in a static state while selecting the white point.

Another innovative aspect described in this disclosure can be implemented in a non-transitory tangible computer storage medium. The medium can have instructions stored thereon that when executed by a computing system, can cause the computer system to perform operations. The operations can include receiving a selection of a white point for a display device, accessing information that correlates white points with bias voltages for first, second and third display elements of the display device, and using the information to determine the corresponding bias voltages for the selected white point. Receiving the selection of the white point can include receiving the direction via a user interface. In some implementations, accessing information can include accessing a database that stores information correlating white points with bias voltages. In some other implementations, accessing information can include accessing a formula that correlates white points with bias voltages. The formula can include a fixed relationship between the bias voltages for the first, second and third display elements.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a cross-sectional schematic illustration of a red interferometric modulator with an applied voltage (applied electro-static force) of 0 volts.

FIGS. 9B and 9C show examples of cross-sectional schematic illustrations of red interferometric modulators with bias voltages of V_{red}_{₁} and V_{red}_{₂} respectively.

FIG. 9D shows an example of a cross-sectional schematic illustration of a green interferometric modulator with an applied voltage (applied electro-static force) of 0 volts.

FIGS. 9E and 9F show examples of cross-sectional schematic illustrations of green interferometric modulators with bias voltages of V_{green}_{₁} and V_{green}_{₂} respectively.

FIG. 9G shows an example of a cross-sectional illustration of a blue interferometric modulator with an applied voltage (applied electro-static force) of 0 volts.

FIGS. 9H and 9I show examples of cross-sectional schematic illustrations of blue interferometric modulators with bias voltages of V_{blue}_{₁} and V_{blue}_{₂} respectively.

FIG. 10 shows an example characterization of the colors output by an interferometric modulator display when different voltages are used in the on-state of the interferometric modulator.

FIG. 11 shows an enlarged view of the white points depicted in FIG. 10.

FIG. 12 shows an example method for setting a white point of a display device.

FIG. 13 shows another example method for setting a white point of a display device.

FIGS. 14A and 14B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

A display device can be fabricated using one or more implementations of a set of display elements such as spatial light modulating elements (e.g., interferometric modulators). For example, the display device can include first, second, and third interferometric modulators, each modulator configured to output light of a distinct color (e.g., red, green, and blue). Each display element can have an on-state where a reflective surface is positioned at a distance from a partially reflective surface such that the display element can reflect incident light having a resonant wavelength. Each distance can depend at least in part on a bias voltage. In some implementations, the bias voltages for the display elements are non-zero in the on-states.

The display device can include electronics configured to drive the display elements. The electronics can be electrically connected to the display elements to provide the non-zero bias voltages. In some implementations, the electronics can access either a database or a formula to establish the bias voltages. The database or formula can provide a correlation between the bias voltages and another characteristic, e.g., white point. The white point of a display device can be the hue that is considered to be generally neutral (e.g., gray or achromatic). The white point of a display device may be characterized based on a comparison of white light produced by the device with the spectral content of light emitted by a black body at a particular temperature (“black body radiation”). Thus, by knowing a relationship between white point and the bias voltages, the display device can be configured to control a white point of the display device by adjusting the bias voltages of the display elements in the non-zero voltage on-states.

Particular implementations of the subject matter described in this disclosure can be implemented to realize one or more of the following potential advantages. For example, a user may react more favorably to a display with a certain white point than a display with another white point in a particular environment, e.g., a user may react favorably to a display with a white point similar to natural sunlight than to a display with a white point similar to a home environment. Thus, a user may prefer displays with certain white points over displays with other white points. Since a user's response to a display can be affected by the white point of a display, control over the white point can be desirable to improve user satisfaction with the display. Additionally, providing a display with a white point that matches a standardized white point may be desirable, e.g., in order to manufacture displays with similar white points among different manufacturers. In addition, certain images can be coded with an assumption about the white point of the display. If the white point of the display is different from the assumed white point, white areas in the image may take on a hue rather than appearing white. Because this can be detrimental to perceived image quality, certain implementations provide a display device with a white point significantly close to the assumed white point, e.g., a standardized white point. In certain implementations, users also can adjust the white point of the display to the user's preference. For example, since changing the white point can change the colors on a display, in some implementations, users can adjust the white point so that images can appear warmer or cooler than the default setting.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

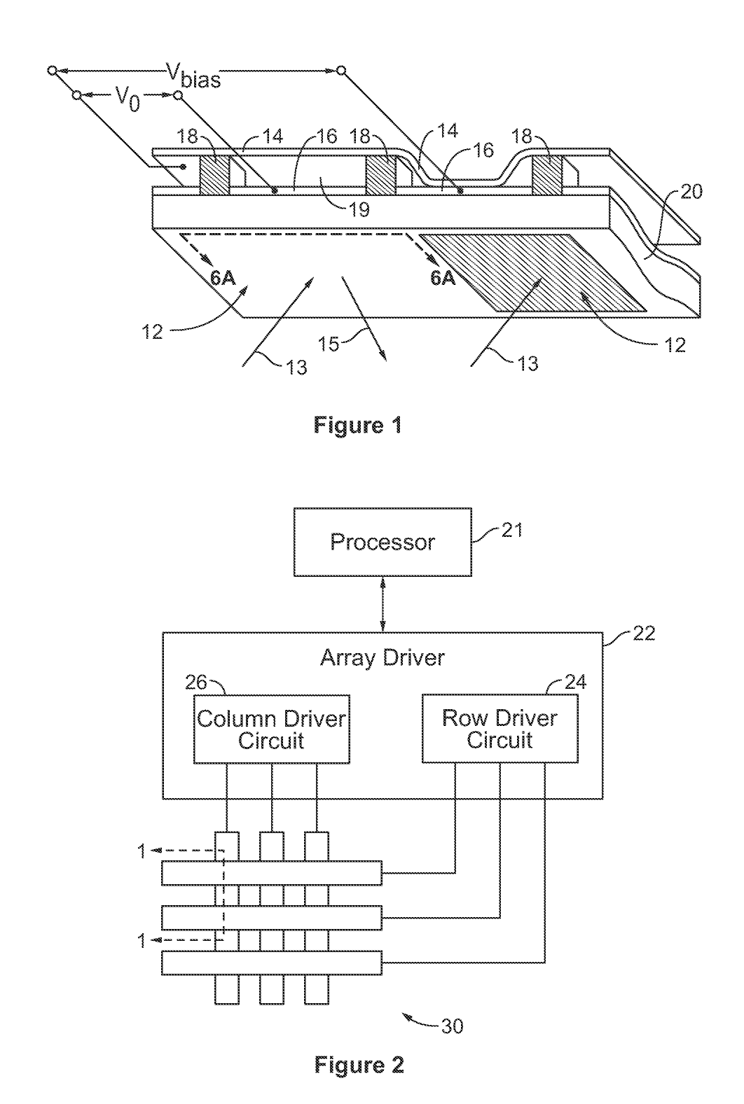

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

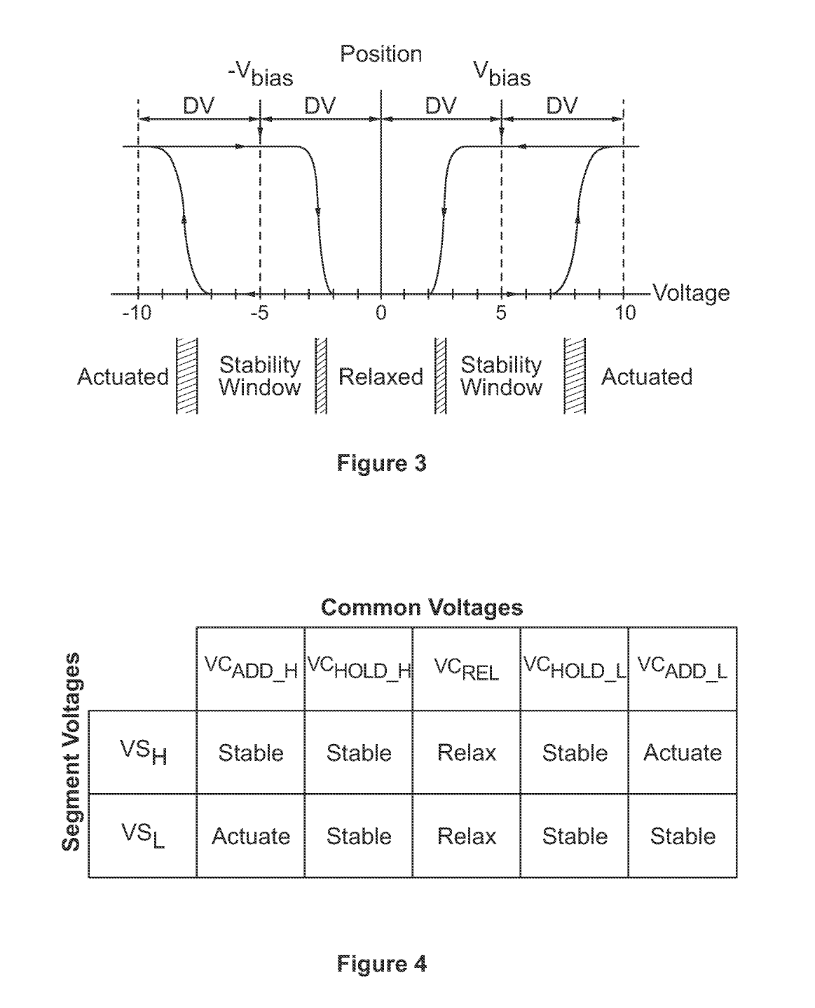

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

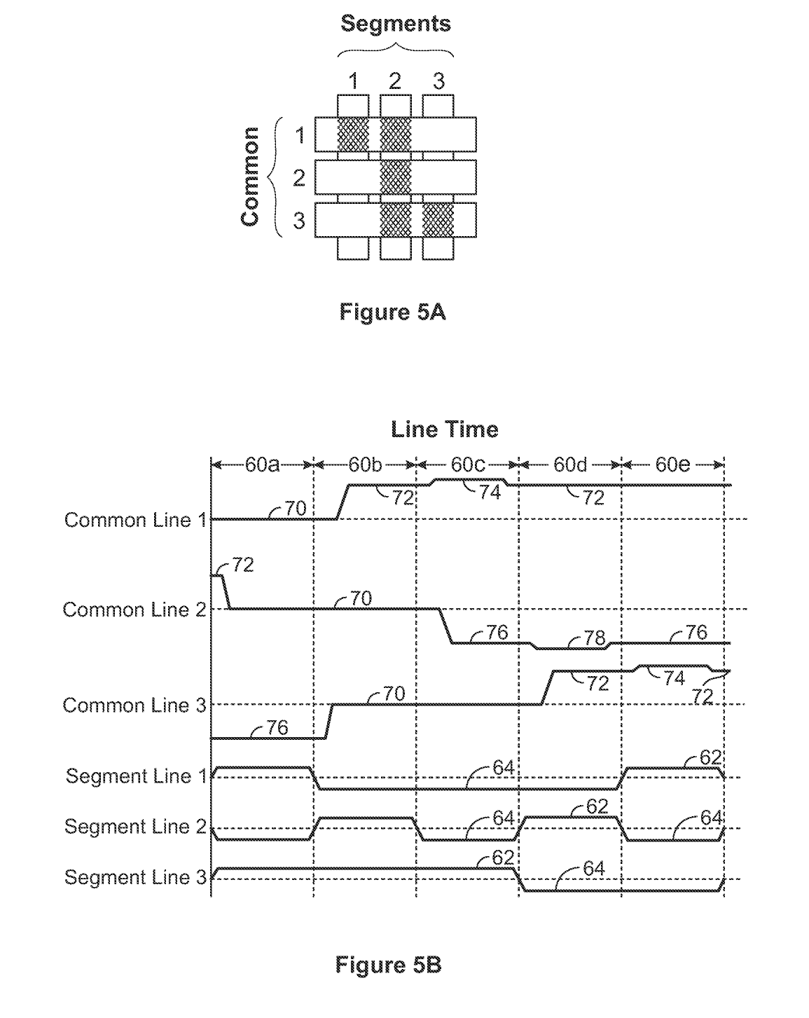

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

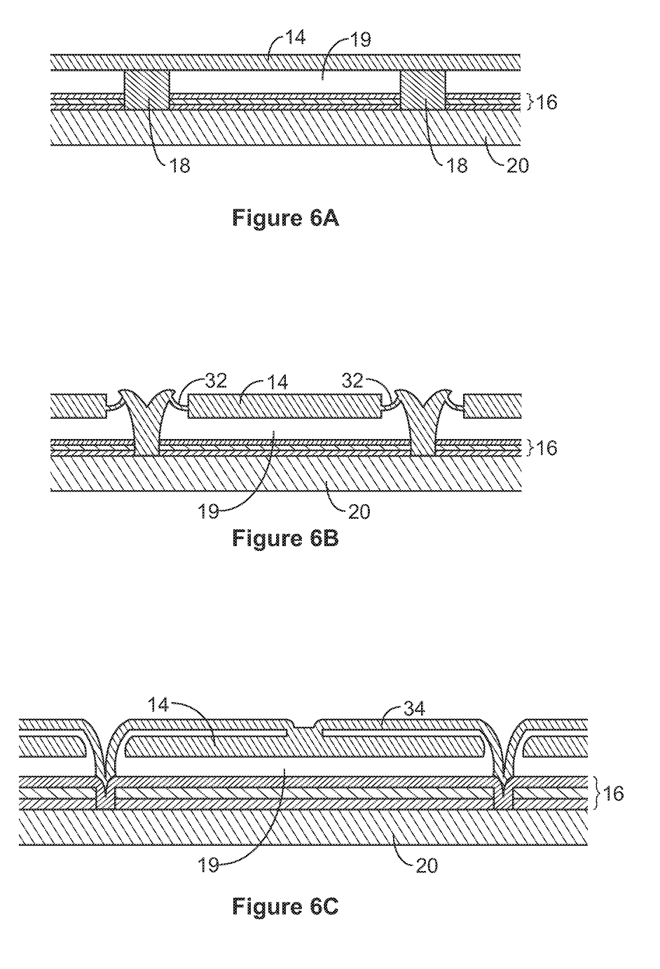

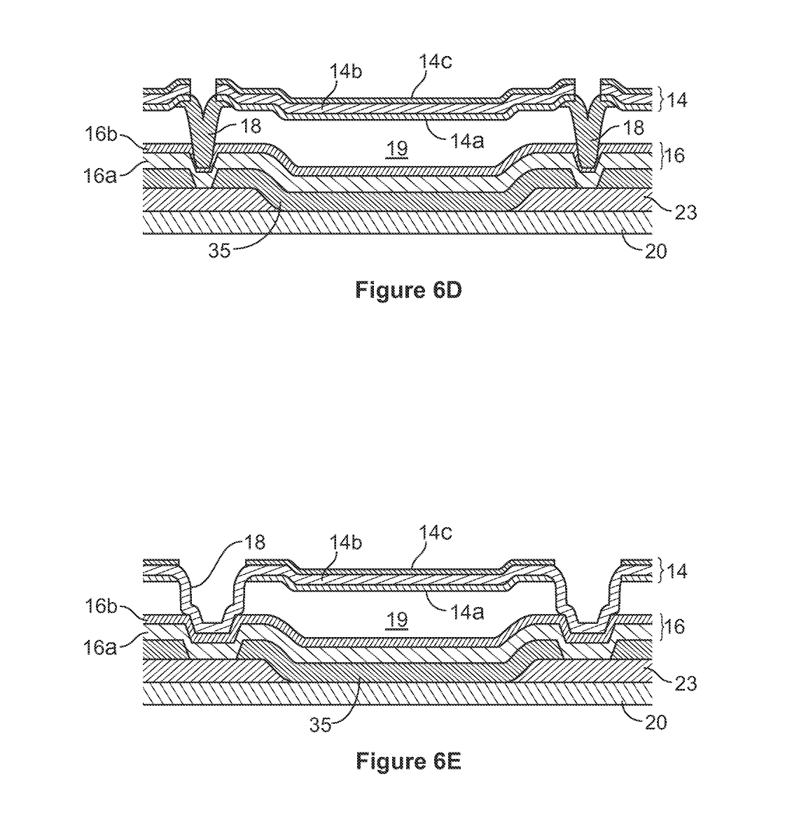

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

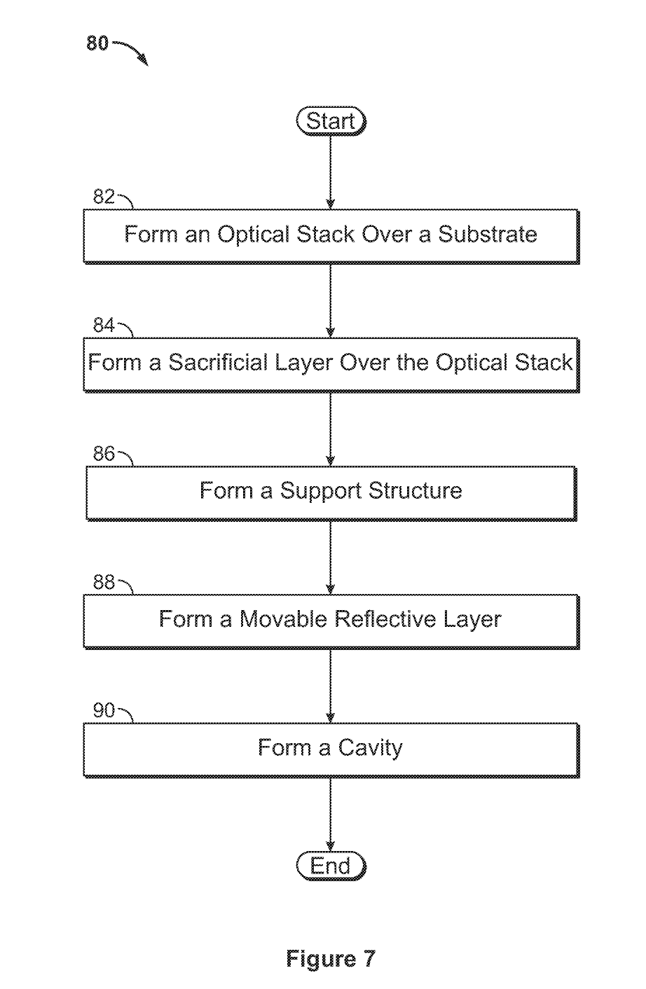

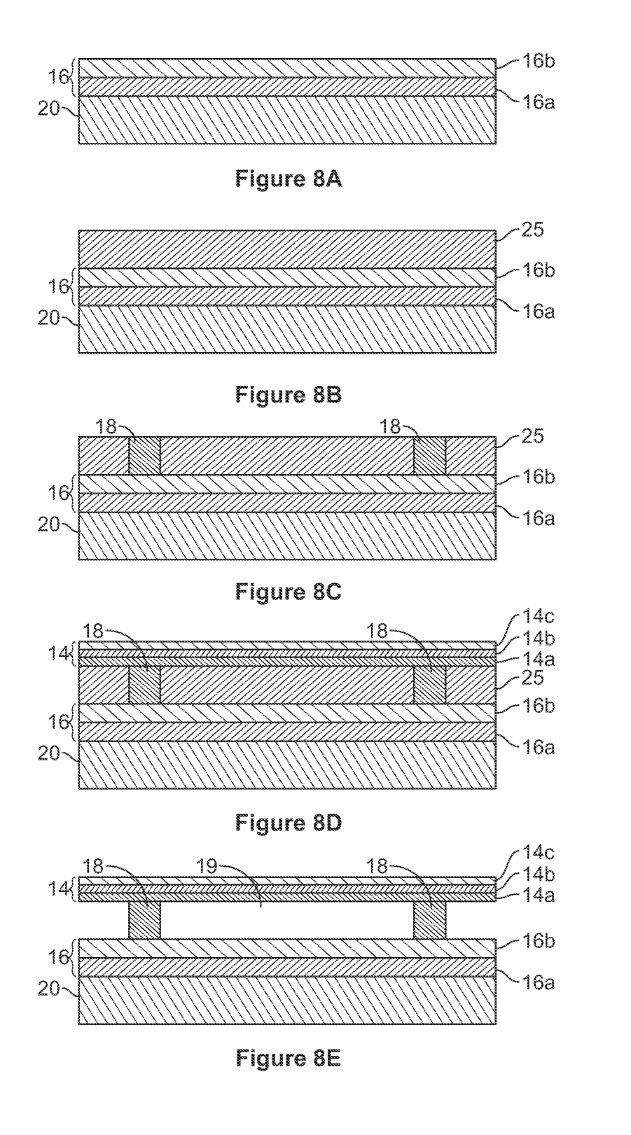

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

The white point of a display is the hue that is considered to be generally neutral (such as gray or achromatic). The white point of a display may be characterized based on a comparison of white light produced by the device with the spectral content of light emitted by a black body at a particular temperature (“black body radiation”). A black body radiator is an idealized object that absorbs all light incident upon the object and which re-emits the light with a spectrum dependent on the temperature of the black body radiator. For example, the black body spectrum at 6,500 K may be referred to as white light having a color temperature of 6,500 K. Such white points having color temperatures of approximately 5,000-10,000 K are generally identified with daylight.

The International Commission on Illumination (CIE) promulgates standardized white points of light sources. For example, light source designations of “D” refer to daylight. In particular, standard white points D₅₅, D₆₅, and D₇₅, which correlate with color temperatures of 5,500 K, 6,500 K, and 7,500 K, are examples of standard daylight white points.

A display device may be characterized by the white point of the white light produced by a display. The white point may be represented by the u′ and v′ coordinates of a CIE XYZ chromaticity diagram. Changing the white point of a display can change the overall color of the display. In various implementations, the white point closely matches the color of a black body radiator at a certain temperature, e.g., 6,500 K. Accordingly, the white point of such a display can be characterized by the color temperature. A display with a lower color temperature, e.g., 5,500 K, can be perceived as having a yellowish white, while a display with a higher color temperature, e.g., 7,500 K, can be perceived as having a bluish white. Users viewing the display device generally respond more favorably to displays having higher temperature white points. Thus, providing control over the white point of the display can be useful in improving user satisfaction with the display and providing white points that match black body radiators also may be desirable in order to manufacture displays that can be adjusted to conform to a white point standard (e.g., D₅₅, D₆₅, or D₇₅). For example, if the white point of the display is different than the assumed white point coded in an image, white areas can take on a hue. Certain implementations can provide a display device with a white point significantly close to the assumed white point, e.g., a standardized white point. In addition, because changing the white point can change the colors on a display, in some implementations, users can adjust the white point of the display to the user's preference so that images can appear warmer or cooler than the default setting.

As discussed above, in some implementations, the pixels of the display elements can be in either a bright or dark state. In the bright (“relaxed,” “open,” or “on”) state, the display element reflects a large portion of incident visible light, e.g., to a user. Conversely, in the dark (“actuated,” “closed,” or “off”) state, the display element reflects little incident visible light. A device that switches between two states, e.g., from on to off state (open to closed) may be referred to as a bi-stable or digital display device (e.g., bi-stable or digital modulator, bi-stable or digital display element, bi-stable or digital interferometric modulator, etc.), in comparison, for example, to an analog display device. In some implementations, images are produced by using a set of bi-stable display elements or bi-stable interferometric modulators that either are in a bright state or are in a dark state. When in a bright state, the display element can output colored or white light. When in a dark state, the display element can reflect little incident visible light. Electronics, e.g., driver electronics, may be configured to drive the modulators in a manner so as to be bi-stable or digital, producing an image by selectively switching between an on-state and an off-state. As described above, in some implementations, the interferometric modulator has a zero bias voltage in the released or “on” state (hereinafter “on-state”).

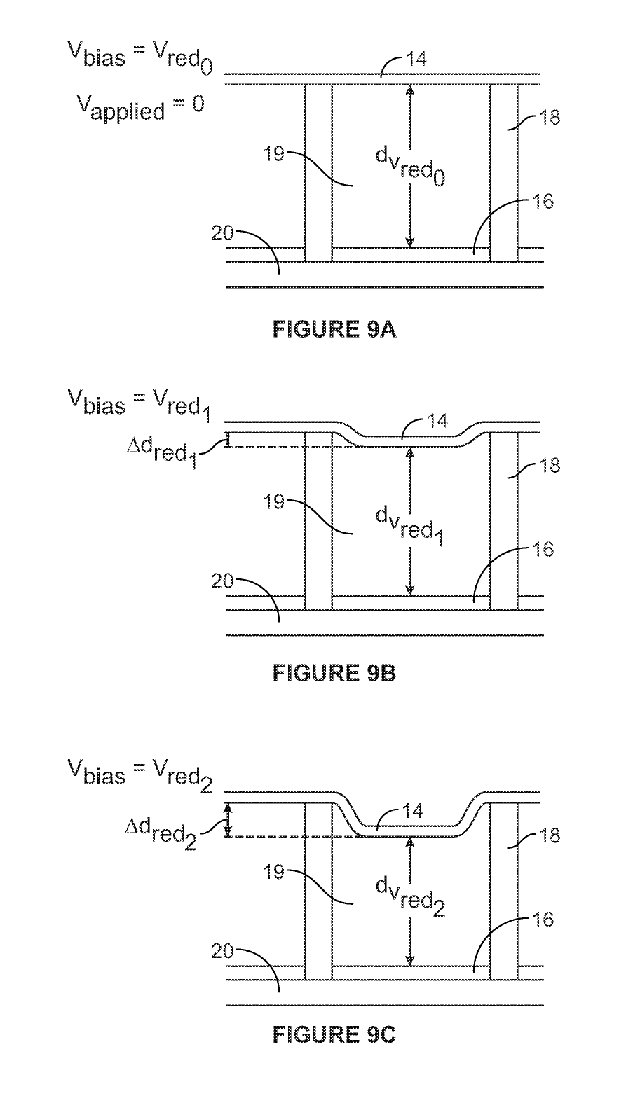

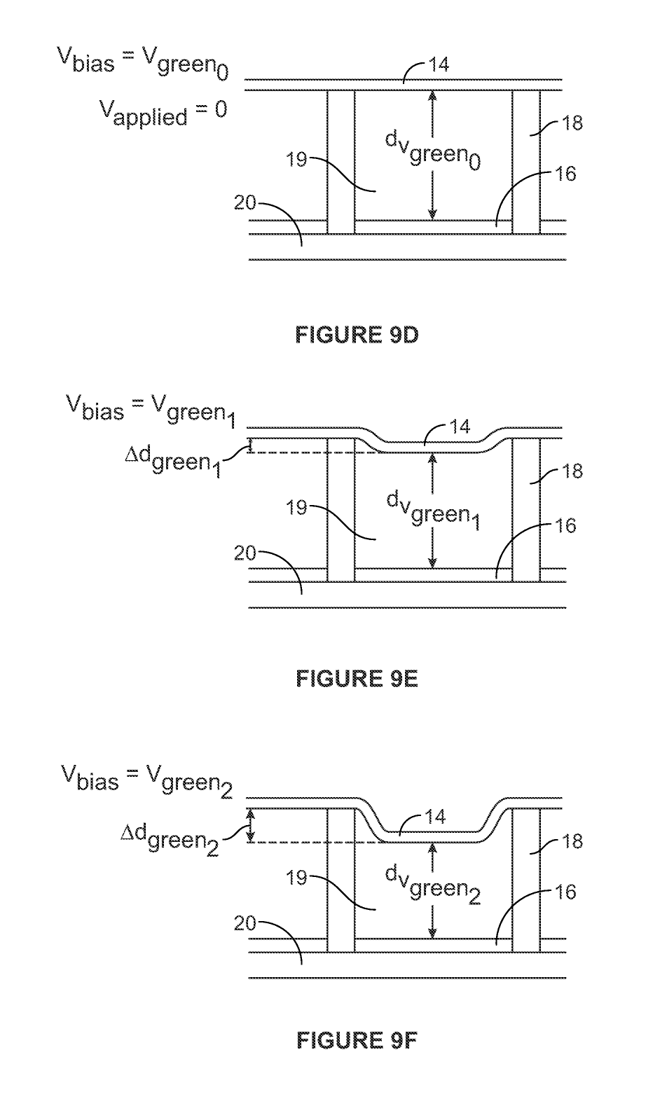

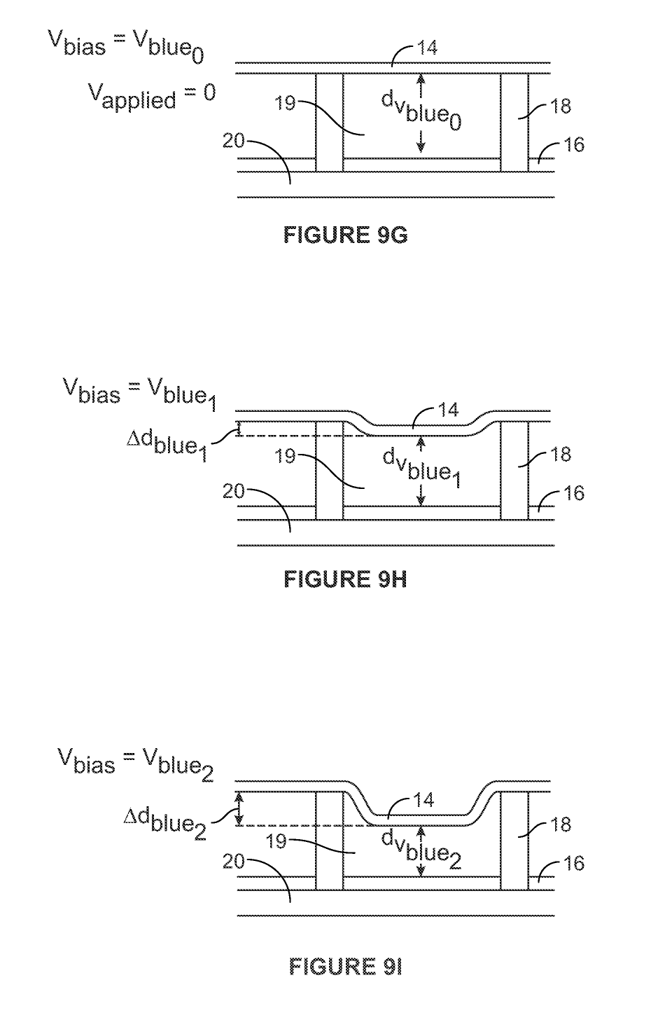

FIG. 9A shows an example of a cross-sectional schematic illustration of a red interferometric modulator with an applied voltage (applied electro-static force) of 0 volts. As discussed herein, the optical cavity or gap 19 can be formed between the movable reflective layer 14 and the optical stack 16. The distance between the movable reflective layer 14 and the optical stack 16 can be referred to as d. As discussed herein, the distance d can be adjusted based at least in part on the applied voltage. In the example red interferometric modulator with an applied voltage of 0 volts, this distance may be denoted as d_{Vred}_{₀}, and can be referred to as an optical path length which can be related to the color of light, e.g., red, reflected by the interferometric modulator. In various implementations, interference (constructive or destructive) between the light reflected from the partially reflective layer of the optical stack 16 and the light reflected from the movable reflective layer 14 determines the wavelength(s) of light reflected from the pixel. Similar to FIG. 1, the interferometric modulator shown in FIG. 9A has a bias voltage of zero in the on-state. By having a zero bias voltage in the on-state, the interferometric modulator can remain in the on-state, e.g., the distance between the movable layer 14 and the optical stack 16 can remain at d_{Vred}_{₀}, when no voltage is applied. When the applied voltage is greater than or equal to the bias voltage V_{red}_{₀} used to actuate the interferometric modulator, the movable reflective layer 14 can move a distance d_{Vred}_{₀} towards the optical stack 16; and the interferometric modulator can turn to the off-state.

In some other implementations, the display device has a bias voltage in the on-state, which allows control over the white point of the display. FIGS. 9B and 9C show examples of cross-sectional schematic illustrations of red interferometric modulators with bias voltages of V_{red}_{₁} and V_{red}_{₂} respectively. In FIG. 9B, the bias voltage to actuate the interferometric modulator can be adjusted to V_{red}_{ᵢ}, such that the distance between the movable reflective layer 14 and the optical stack 16 can be adjusted to d_{Vred}_{₁}. In this implementation, not only is there a non-zero bias voltage V_{red}_{₁} to actuate the interferometric modulator to the off-state, but the interferometric modulator can have a non-zero bias voltage in the on-state, e.g., a positive (or negative) voltage to hold the interferometric modulator in the on-state yet establishing an appropriate distance between reflective surfaces such as the movable reflective layer 14 and the optical stack 16 to output a specific color.

The non-zero bias voltage in the on-state can result in a relative displacement Δd_{red}_{₁} of the reflective layer 14, which is the difference between d_{Vred}_{₀} and d_{Vred}_{₁}. The distance Δd_{red}_{₁} can be a percentage of d_{Vred}_{₀}, such that the color of light reflected by the interferometric modulator is still perceived as red, yet also can be tuned to a different hue of red. For example, in some implementations, the difference in distance between d_{Vred}_{₀} and d_{Vred}_{₁} can be less than about 1%, between about 1% to 2%, between about 2% to 3%, between about 3% to 4%, between about 4% to 5%, between about 5% to 6%, between about 6% to 7%, between about 7% to 8%, between about 8% to 9%, between about 9% to 10%, equal to about 10% or greater than 10% of d_{Vred}_{₀} in either a direction with the movable reflective layer 14 closer to the optical stack 16 or in a direction with the movable reflective layer 14 farther away from the optical stack 16.

When a voltage of V_{red}_{₁} is applied, the movable reflective layer 14 can move a distance d_{Vred}_{₁} towards the optical stack 16. The interferometric modulator can thereby be actuated to the off-state. When returning to the on-state, the applied voltage for the interferometric modulator shown in FIG. 9B can be non-zero, e.g., the interferometric modulator has a non-zero bias voltage in the on-state that establishes the electro-statically induced displacement or shift (Δd_{red}_{₁}) in the movable layer 14 in comparison to being completely relaxed or open with no applied electro-static force. The distance d_{Vred}_{₁} can be less than the distance d_{Vred}_{₀} of the red interferometric modulator shown in FIG. 9A. In some implementations, the distance d_{Vred}_{₁} also can be greater than the distance d_{Vred}_{₀} (not shown). For example, the movable reflective layer 14 can move in a direction away from the optical stack 16.

The red interferometric modulator can be further tuned as shown in FIG. 9C. In this example, the bias voltage can be adjusted to V_{red}_{₂}, thereby applying a different electro-static force such that the distance between the movable reflective layer 14 and the optical stack 16 can be adjusted to d_{Vred}_{₂}. In FIG. 9C, the electro-statically induced displacement Δd_{red}_{₂} is larger than Δd_{red}_{₁} such that the distance d_{Vred}_{₂} is less than the distance d_{V}_{_{red1}}. In some other implementations, the distance d_{Vred}_{₂} can be greater than the distance d_{V}_{_{red1}}. The difference in distance between d_{Vred}_{₀} and d_{Vred}_{₂} can be a percentage of d_{Vred}_{₀}, such that the color of light reflected by the interferometric modulator is still red, yet also can be tuned to a different hue of red. For example, in some implementations, the difference in distance between d_{Vred}_{₀} and d_{Vred}_{₂} can be less than about 1%, between about 1% to 2%, between about 2% to 3%, between about 3% to 4%, between about 4% to 5%, between about 5% to 6%, between about 6% to 7%, between about 7% to 8%, between about 8% to 9%, between about 9% to 10%, equal to about 10% or greater than 10% of d_{Vred}_{₀} in either a direction with the movable reflective layer 14 closer to the optical stack 16 or in a direction with the movable reflective layer 14 farther away from the optical stack 16.

FIG. 9D shows an example of a cross-sectional schematic illustration of a green interferometric modulator with an applied voltage (applied electro-static force) of 0 volts. Similar to the interferometric modulator in FIG. 9A, the interferometric modulator in FIG. 9D can have a bias voltage or applied electro-static force of zero in the on-state. The posts 18 of FIG. 9D can have a smaller height compared to the red interferometric modulator shown in FIG. 9A. This results in a distance d_{Vgreen}_{₀} between the movable reflective layer 14 and the optical stack 16 that can be less than d_{Vred}_{₀} such that the reflected color of light is green.

FIGS. 9E and 9F show examples of cross-sectional schematic illustrations of green interferometric modulators with bias voltages of V_{green}_{₁} and V_{green}_{₂} respectively. Similar to FIG. 9B, FIG. 9E shows a green interferometric modulator with a non-zero bias voltage or applied electro-static force in the on-state. The bias voltage to actuate the interferometer modulator can be adjusted to V_{green}_{₁}, such that the distance between the movable reflective layer 14 and the optical stack 16 is d_{Vgreen}_{₁}. In FIG. 9E, the distance d_{Vgreen}_{₁} can be less than the distance d_{Vgreen}_{₀}. In other implementations, the distance d_{Vgreen}_{₁} can be greater than the distance d_{Vgreen}_{₀}. The green interferometric modulator can be further tuned as shown in FIG. 9F. In this example, the bias voltage is adjusted to V_{green}_{₂}, such that the distance between the movable reflective layer 14 and the optical stack 16 can be adjusted to d_{Vgreen}_{₂}. The distance d_{Vgreen}_{₂} can be less than (as illustrated in FIG. 9F) or greater than the distance d_{Vgreen}_{₁}.

Similar to FIGS. 9B and 9C, the green interferometric modulators shown in FIGS. 9E and 9F can have non-zero bias voltages in the on-state, e.g., positive (or negative, as a person having ordinary skill in the art will readily recognize) voltages holding the interferometric modulator in the on-state. The non-zero bias voltage in the on-state can result in a distance Δd_{green}_{₁} which is the difference between d_{Vgreen}_{₀} and d_{Vgreen}_{₁}, or Δd_{green}_{₂}, which is the difference between d_{Vgreen}_{₀} and d_{Vgreen}_{₂}. The applied electric fields establish the electro-statically induced displacement or shift, Δd_{Vgreen}_{₁}, or Δd_{geen}_{₂}, respectively, in the movable layer 14 in comparison to being completely relaxed or open with no applied electro-static field or force. The difference in distance Δd_{green}_{₁} or Δd_{green}_{₂} can be less than about 1%, between about 1% to 2%, between about 2% to 3%, between about 3% to 4%, between about 4% to 5%, between about 5% to 6%, between about 6% to 7%, between about 7% to 8%, between about 8% to 9%, between about 9% to 10%, equal to about 10% or greater than 10% of d_{Vgreen}_{₀} in either a direction with the movable reflective layer 14 closer to the optical stack 16 or in a direction with the movable reflective layer 14 farther away from the optical stack 16 such that the color of light reflected by the interferometric modulator is still green, yet also can be tuned to a different hue of green color.

FIG. 9G shows an example of a cross-sectional illustration of a blue interferometric modulator with an applied voltage (applied electro-static force) of 0 volts. The color of light reflected from the blue modulator is blue. Similar to FIGS. 9A and 9D, FIG. 9G has a bias voltage or applied electro-static force of 0 volts in the on-state. The posts 18 of FIG. 9G can have a smaller height compared to the red and green interferometric modulators shown in FIGS. 9A and 9D respectively. Having a smaller height, the distance d_{Vblue}_{₀} between the movable reflective layer 14 and the optical stack 16 can be less than d_{Vred}_{₀} of the red interferometric modulator and less than d_{Vgreen}_{₀} of the green interferometric modulator.

FIGS. 9H and 9I show examples of cross-sectional schematic illustrations of blue interferometric modulators with bias voltages of V_{blue}_{₁} and V_{blue}_{₂} respectively. Similar to FIGS. 9B, 9C, 9E and 9F, FIGS. 9H and 9I each show a blue interferometric modulator with a non-zero bias voltage (or applied electro-static force) in the on-state, e.g., a positive or negative voltage holding the interferometric modulator in the on-state. The bias voltage to actuate the interferometric modulator can be adjusted to V_{blue}_{₁} or V_{blue}_{₂}, such that the distance between the movable reflective layer 14 and the optical stack 16 can be adjusted to a distance, d_{Vblue}_{₁} or d_{Vblue}_{₂}, which can be less than or greater than the distance d_{Vblue}_{₀}. The applied electric fields establishes the electro-statically induced displacement or shift, Δd_{Vblue}_{₁}, or Δd_{blue}_{₂}, respectively, in the movable layer 14 in comparison to being completely relaxed or open with no applied electro-static field or force. The difference in distance between d_{Vblue}_{₀} and d_{Vblue}_{₁} (Δd_{blue}_{₁}) or between d_{Vblue}_{₀} and d_{Vblue}_{₂} (Δd_{blue}_{₂}) can be less than about 1%, between about 1% to 2%, between about 2% to 3%, between about 3% to 4%, between about 4% to 5%, between about 5% to 6%, between about 6% to 7%, between about 7% to 8%, between about 8% to 9%, between about 9% to 10%, equal to about 10% or greater than 10% of d_{Vblue}_{₀} in either a direction with the movable reflective layer 14 closer to the optical stack 16 or in a direction with the movable reflective layer 14 farther away from the optical stack 16 such that the color of light reflected by the interferometric modulator is still blue, yet also can be tuned to a different hue of blue color. Although FIGS. 9A-9C, 9D-9F, and 9G-9I schematically depict display elements configured to output red, green, and blue light, respectively, this is intended to be illustrative and not limiting. In other implementations, the display elements may be configured to output light of different colors than red, green, and blue (e.g., cyan, magenta, and yellow). In yet other implementations, the display device may include four (or more) display elements configured to output four (or more) colors (e.g., red, green, blue, and white).

Some implementations can provide a display device configured to control a white point. The display device can include a set of display elements. In some implementations, the display elements can include at least one display element configured to output red light, at least one display element configured to output green light, and at least one display element configured to output blue light. In other implementations, the display elements can output different colors of light than red, green, and blue (e.g., cyan, magenta, and yellow). In other implementations, the set of display elements can output four (or more) colors of light, which may in some cases provide a larger color gamut and/or higher brightness than may generally be available using a set of display elements that output three colors. For example, in some implementations, the set of display elements may be configured to output red, green, blue, and white light or red, green, blue, cyan, magenta, and yellow light.

Each display element can include an interferometric modulator. FIG. 1 shows two adjacent interferometric modulators 12. The interferometric modulator 12 on the left has an on-state as discussed above, where a movable reflective layer 14 (i.e., a reflective surface) is positioned at a distance from an optical stack 16 (i.e., a partially reflective surface) such that the display element reflects incident light having a resonant wavelength in the visible range. In some implementations, as discussed above, the distance between a reflective surface 14 and a partially reflective surface 16 of an interferometric modulator can depend at least in part on a bias voltage V_{bias}. As shown in FIGS. 1, 9A, 9D and 9G, some implementations include display elements where the bias voltages for the red, green, and blue display elements are zero in the on-states.

In some other implementations, the display elements can have bias voltages for the red, green, and blue display elements that are non-zero in the on-states. Such as in FIGS. 9B, 9C, 9E, 9F, 9H and 9I. By having a non-zero bias voltage for the on-state of the display element, the color of the light reflected by the interferometric modulator, e.g., red, green, or blue, can be controlled and adjusted. Similarly, by having non-zero bias voltages for the on-states for the red, green, and blue display elements, the white point of the display device can be controlled, adjusted, and/or tuned. Thus, in some implementations, the bias voltages for the red, green, and blue display elements can be adjustable to control a white point in the on-states. In some implementations, the white point can be a standardized white point, e.g., D₅₅, D₆₅, or D₇₅. To adjust the bias voltages, various implementations of a display device can include electronics configured to drive the different display elements. The electronics can be electrically connected to the display elements to provide the non-zero bias voltages. In some implementations as described herein, the electronics can include a driver controller and an array driver.

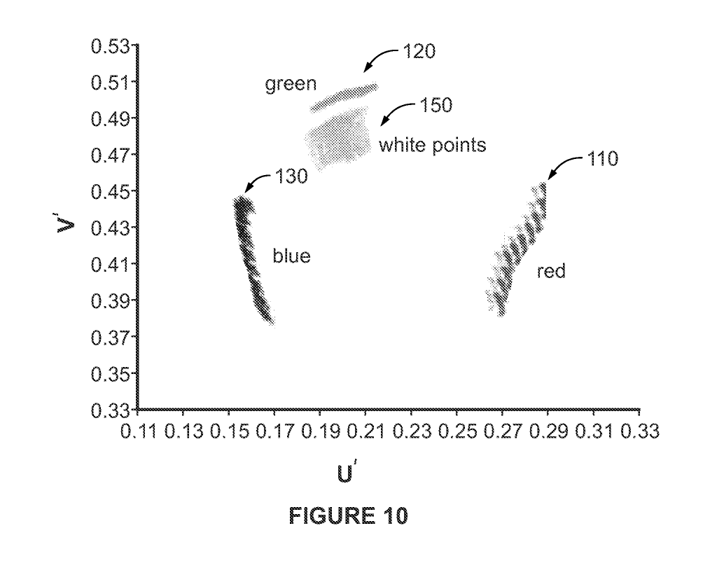

Associated with some implementations of the display device can be a look-up table (LUT) or database that correlates color temperature and bias voltages. This database can be generated, for example, by first characterizing the display. FIG. 10 shows an example characterization of the colors output by an interferometric modulator display when different bias voltages are used in the on-state of the interferometric modulator. While holding constant the bias voltages for two primary colors (e.g., red and green) in either the on-state or off-state, the voltage of the third primary color (e.g., blue) can be varied. In this example, the composite color associated with eight color patches, e.g., red, green, blue, cyan, magenta, yellow, black, and white, can be measured. The colors associated with each voltage step for seven constituent pixel components, e.g., red on-state, red off-state, green on-state, green off-state, blue on-state, blue off-state, and a black mask, can be computed.

Using these color values of the pixel constituent components, the colors, e.g., the u′ and v′ chromaticity coordinates of the CIE XYZ chromaticity diagram, associated with red, green, and blue on-states and off-states for a variety of voltages can be determined. An example of the determined red colors 110, green colors 120, and blue colors 130 plotted on a chromaticity diagram for a variety of different voltages can be seen in FIG. 10. Possible white point chromaticity coordinates by using the red, green, and blue on-state and off-state chromaticity coordinates can then be computed. For example, a chromaticity coordinate from the red colors 110, a chromaticity coordinate from the green colors 120, and a chromaticity coordinate from the blue colors 130 can be used to compute a white point chromaticity coordinate of the light produced by a combination of these colors. In particular, in some implementations, since the color white can be formed when each of a red, green, and blue pixel is in the on-state, the white point chromaticity coordinate can be computed as the weighted sum of the red, green, and blue chromaticity coordinates. In some implementations, additional chromaticity coordinates can be interpolated. Some examples of computed possible white point chromaticity coordinates 150 are shown in FIG. 10. In some implementations, the computed possible white points 150 and the voltages that produced these white points can be included in a database. In such an implementation, the corresponding voltages for the red, green, and blue display elements can be determined for a desired white point. As will be discussed further below, in some other implementations, the computed possible white points 150 can be compared to the white points of black body radiators at different temperatures.

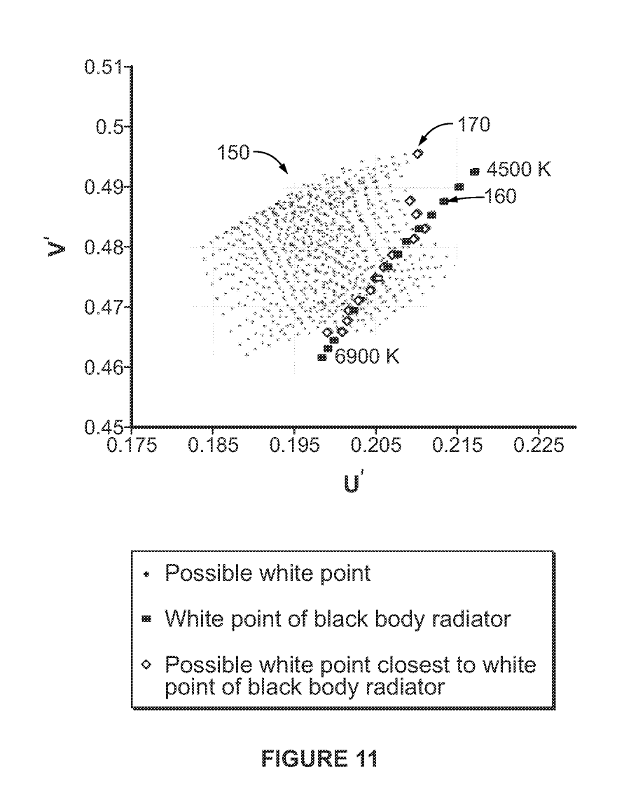

FIG. 11 shows an enlarged view of the white points depicted in FIG. 10. For example, the white points 150 are some example computed possible white points. FIG. 11 also shows the white points of black body radiators at different color temperatures (filled squares 160). The color temperatures, e.g., 4,500 K through 6,900 K, that the display is capable of generating can be determined. The white point from the previously computed possible white point chromaticity coordinates 150 closest to the white points of the black body radiators at different temperatures (squares 160) can be selected. These white points are depicted as open diamonds 170 in FIG. 11.

The voltages that produce these white points can be included in a database. For example, a database can be created that correlates color temperature with the voltage settings that generated the white point closest to a particular color temperature. These voltages are possible bias voltages for some implementations. An example database is shown in the Table 1.

TABLE 1

| | | | Corresponding | | | | |
|---|---|---|---|---|---|---|---|
| | | | display | | | | |
| | | | chromaticities | | | | |
| | Blackbody | | (closest to | | | | |
| Color | chromaticities | | blackbody) | | Bias voltages | | |
| Temperature | u′ | v′ | u′ | v′ | R | G | B |
| 4500 | 0.217 | 0.493 | 0.210 | 0.496 | 11.2 | 7 | 6.7 |
| 4650 | 0.215 | 0.490 | 0.209 | 0.488 | 11.2 | 7 | 8.7 |
| 4800 | 0.214 | 0.488 | 0.210 | 0.486 | 11.2 | 7 | 9.2 |
| 4950 | 0.212 | 0.486 | 0.210 | 0.486 | 11.2 | 7 | 9.2 |
| 5100 | 0.210 | 0.483 | 0.211 | 0.483 | 11.2 | 7 | 9.7 |
| 5250 | 0.209 | 0.481 | 0.210 | 0.481 | 10.7 | 7 | 9.7 |
| 5400 | 0.208 | 0.479 | 0.207 | 0.479 | 9.7 | 7 | 9.7 |
| 5550 | 0.206 | 0.477 | 0.206 | 0.477 | 10.2 | 8 | 10.2 |
| 5700 | 0.205 | 0.475 | 0.205 | 0.475 | 9.2 | 7.5 | 10.2 |
| 5850 | 0.204 | 0.473 | 0.204 | 0.473 | 10.2 | 9 | 11.2 |
| 6000 | 0.203 | 0.471 | 0.203 | 0.471 | 7.2 | 7 | 10.2 |
| 6150 | 0.202 | 0.470 | 0.202 | 0.469 | 7.7 | 8 | 10.7 |
| 6300 | 0.201 | 0.468 | 0.202 | 0.468 | 6.7 | 7.5 | 10.7 |
| 6450 | 0.201 | 0.466 | 0.201 | 0.466 | 6.7 | 8 | 11.2 |
| 6600 | 0.200 | 0.465 | 0.199 | 0.466 | 6.7 | 8.5 | 11.2 |
| 6750 | 0.199 | 0.463 | 0.199 | 0.466 | 6.7 | 8.5 | 11.2 |
| 6900 | 0.199 | 0.462 | 0.199 | 0.466 | 6.7 | 8.5 | 11.2 |

The color temperature of some implementations of the display device can be set or adjusted using information from a database similar to the example database shown in Table 1. For example, after a particular color temperature for the white point for the display device has been selected (e.g., by a manufacturer or user), the database that stores information correlating color temperature with the bias voltages for each of the red, green, and blue display elements of the display device can be used to determine the bias voltages for each of the red, green, and blue display elements corresponding to the selected color temperature. The display device can then be set to the determined bias voltages. In implementations where the white point is selected at the manufacturing stage, the color temperature preferred by a majority of users can be determined and each display device can be set to the determined value. In certain implementations as will be described further below, a user can select the color temperature with an input device and the display device can be set to the selected value.

In certain implementations described herein, the bias voltages for the red, green, and blue display elements can be non-zero in the on-states. One, some, or all of the bias voltages can be adjustable to control a white point of the display device. In other implementations, at least one of the bias voltages for the display elements can be non-zero in the on-state and adjustable to control the white point of the display device. As one possible example, the bias voltage of a red display element may be non-zero in the on-state and adjusted to control the white point of the display device. The bias voltages of the green and blue display elements can be zero. In some other implementations, at least two of the bias voltages for the display elements can be non-zero in the on-states and adjustable to control the white point of the display device. As one possible example, the bias voltages of a red display element and a green display element may be non-zero in the on-state, and one or both of the bias voltages for the red and green display elements can be adjusted to control the white point of the display device. The bias voltage of the blue display element can be zero. In addition, although the white point discussed herein is specified with a color temperature, other implementations can specify white point in other ways, e.g., with chromaticity coordinates, CIE XYZ values, CIE L*a*b* values, or other color space coordinates.

If implemented in software, the database or functions to produce information from the database may be stored on or transmitted over as one or more data structure, instructions and/or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Some implementations of the display device can be configured to adjust the bias voltages after the bias voltages for the display device have been set. For example, after the bias voltages for the display device have been set, a user can adjust or tune the white point to his or her preference. As discussed below, a processor can access the database to establish the bias voltages for the display device which correspond to a different white point and/or color temperature. The database can be used repeatedly for different environments and different users. For example, the display device can be configured to output D₇₅ light when used in D₆₅ sunlight. As another example, the display device can be configured to output D₇₅ light when used in a room illuminated by an incandescent or fluorescent light. Alternatively, the display device can be configured to output D₆₅ light when used in a room illuminated by an incandescent or fluorescent light.

As discussed herein, the display device of some implementations can include a processor (e.g., the processor 21). This processor can access the database to establish the bias voltages based on the correlation between color temperature and the bias voltages. The processor can be configured to communicate with the display elements to adjust the bias voltages via a driver controller and an array driver. Although certain implementations have been described with bi-stable display elements, e.g., bi-stable interferometric modulators, other implementations can include multi-state display elements, e.g., tri-state interferometric modulators, or analog display elements, e.g., analog interferometric modulators.

In some other implementations, the display device can be set or adjusted using a formula, instead of a database, that correlates color temperature and the bias voltages. In some implementations, the formula can include a function between the red, green and blue voltages for the red, green, blue display elements, respectively. The display device also can include a processor that uses the formula to establish the bias voltages. Similar to the use of the database described above, the formula also can be used repeatedly for different environments and different users.

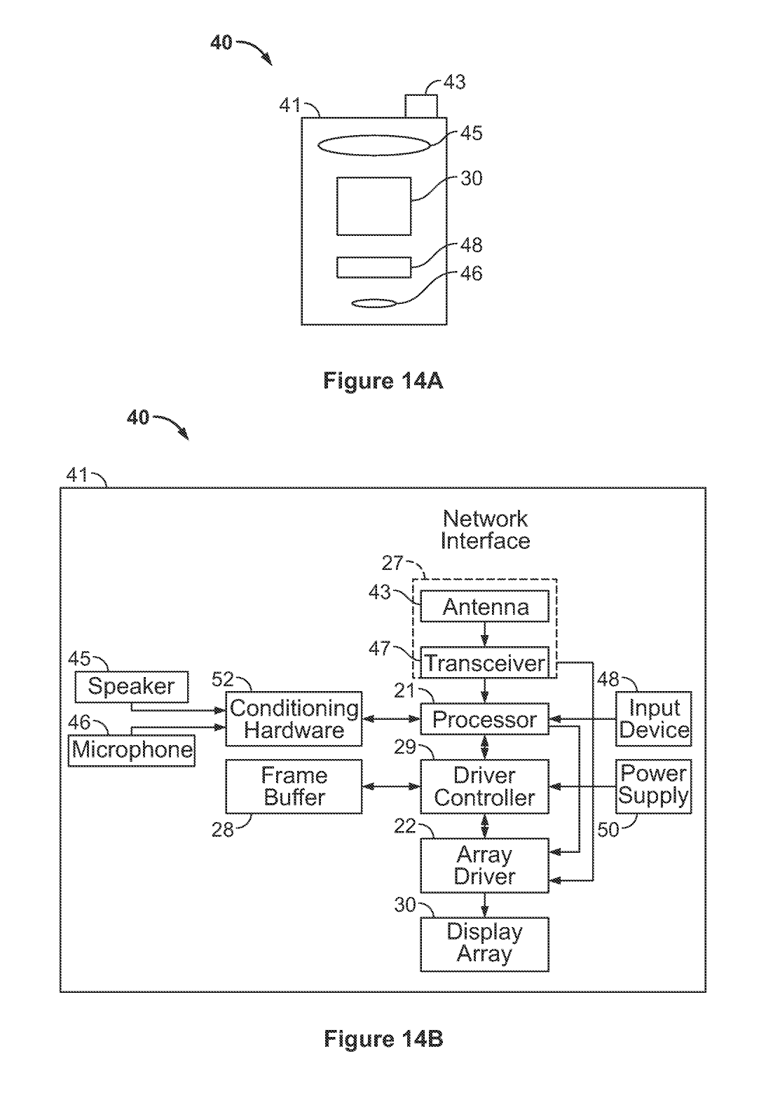

Some implementations of the display device further include a user interface with which a user can adjust the white point of the display. The user interface can be in a variety of forms similar to the input device 48 described below with reference to FIG. 14B, e.g., a knob, a keypad, a button, a switch, a rocker, a touch-sensitive screen, or a pressure- or heat-sensitive membrane. In some such implementations, a user can operate the user interface to adjust or tune the white point by adjusting the bias voltages for the red, green, and blue display elements. For example, in some implementations, the user can input, e.g., on a keypad, a different desired white point or color temperature. In some other implementations, the user can change the white point by preference without knowing the actual white point or color temperature. For example, the user interface may indicate that the white point is to be increased or decreased, e.g., pushing either an “up” or “down” key.

In some implementations, the user interface can be connected to the processor that accesses a database or formula as described above. As discussed above, the bias voltages for the red, green and blue display elements can then be adjusted to the bias voltages corresponding to the user inputted white point, e.g, specified in color temperature, chromaticity coordinates, CIE XYZ values, CIE L*a*b values, or other color space coordinates. By adjusting the bias voltages, the distances between the reflective surface and the partially reflective surface can be adjusted. Because the distances can be adjusted, the white point of the display can be adjusted by tuning at least one resonant wavelength. In some implementations, the image of the display can be held in a static state (e.g., a stationary or still image), while the white point is being adjusted in the static state. For example, a user can read a page of a book displayed on the display while adjusting the white point of the display using the user interface. In some implementations, the adjusted white point can be a standardized white point, e.g, D₅₅, D₆₅, or D₇₅. In some implementations, the white point can be adjusted in a non-static state (e.g., when the display is displaying an image in motion, a slide show, or a video). In some other implementations, adjusting the white point in the static state (e.g., when the display is displaying a stationary or still image) allows a larger range of available voltages.

In some implementations, a user can operate the user interface to adjust the white point by using a fixed relationship between the bias voltages for the red, green, and blue display elements. For example, for every 1 volt the bias voltage for the red display elements goes up, the bias voltage for the blue display elements goes down by about 0.5 volt, and the bias voltage for the green display elements goes up by about 0.25 volt. In certain implementations, the fixed relationship between the display elements can be derived from the database or LUT for each display device. In some implementations, a user can adjust the white point of the display by adjusting a single knob, or other user interface control on a user interface as described herein. In some implementations, the knob can rotate in discrete turns to allow a user to select specific white points, e.g., D₅₅, D₆₅, or D₇₅. In some other implementations, the knob can rotate continuously to allow intermediate white points, e.g., a white point in between D₆₅ and D₇₅.

In some other implementations, a user can adjust the white point of the display by pushing certain buttons on a keypad. For example, a specific set of keys, such as numerical keys, on a keypad can be associated with a different white point associated with a different fixed relationship between the bias voltages for the red, green, and blue display elements. The “1” key can represent a white point associated with a low color temperature, e.g., 4,500 K, while a “9” key can represent a white point associated with a high color temperature, e.g., 6,900 K. As another example, the “up” and “down” keys (or other keys, buttons, etc.) may be used to increase or decrease the white point associated with a different fixed relationship between the bias voltages for the red, green, and blue display elements. For example, if the white point of the display is set at a white point associated with a color temperature of 5,500 K, depressing the “up” key can change the white point of the display to a white point associated with a relatively higher color temperature, e.g., 5,600 K. Another depression of the “up” key can change the white point of the display to a white point associated with an even higher relative color temperature, e.g., 5,700 K. Depression of the “down” key can change the white point of the display to a white point associated with a relatively lower color temperature, e.g., back to 5,600 K. Other devices, such as touch pads, mice, etc can be used. In some implementations, a user can adjust the white point of the display by a finger or stylus, for example, tapping on an icon, image, symbol, alphanumerical text, a soft key or portion thereof within a graphical user interface (GUI) displayed on a touchscreen. Voice activated control also can be used in some implementations.

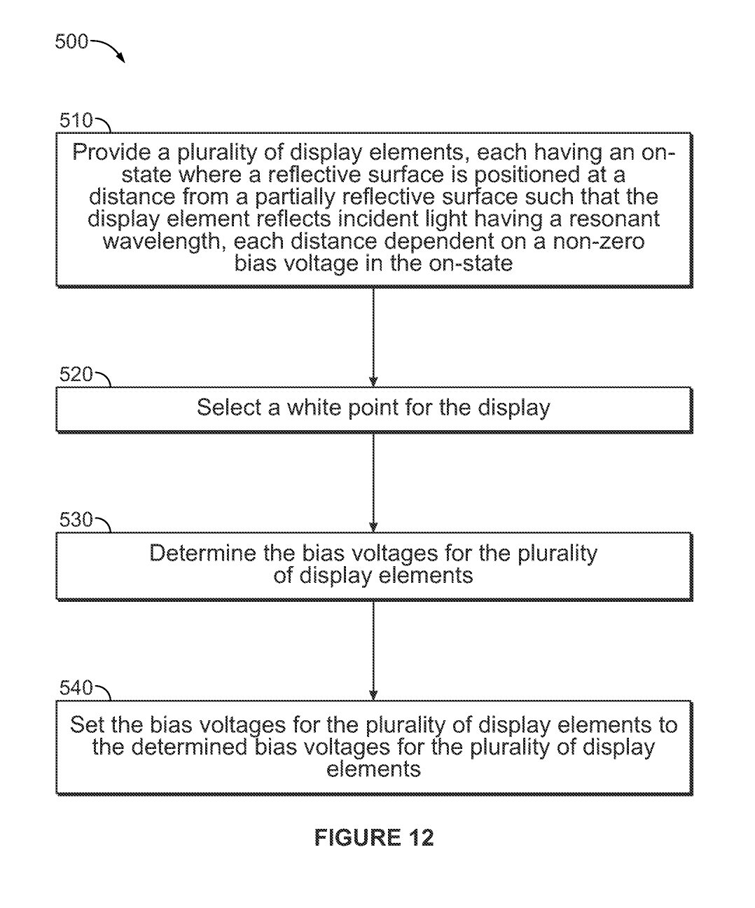

FIG. 12 shows an example method for setting a white point of a display device. The method 500 can be compatible with some implementations of the display described herein. As shown in block 510, the method 500 can include providing a set of display elements. Each display element can have an on-state where a reflective surface of the display element is positioned at a distance from a partially reflective surface of the display element such that the display element reflects incident light having a resonant wavelength. Each distance can be dependent on a non-zero bias voltage in the on-state. The method 500 of some implementations further can include selecting a white point for the display as shown in block 520. Alternatively, a user of the display may select a white point based on the user's preference. Various mechanisms to allow users to select a white point have been discussed above. The user's selection may override the white point previously selected, if any. In some implementations, the method 500 further includes determining the bias voltages for the display elements corresponding to the selected white point as shown in block 530. As shown in block 540, the method 500 further can include setting the bias voltages for the display elements to the determined bias voltages for the display elements.

In some implementations, the display elements can include at least one interferometric modulator configured to output red light, at least one interferometric modulator configured to output green light, and at least one interferometric modulator configured to output blue light. In some implementations, the white light can be characterized by a standardized white point. In some implementations, the display elements can be bi-stable interferometric modulators. In other implementations, the display elements can be multi-state interferometric modulators, e.g., tri-state interferometric modulators. In yet other implementations, the display elements can be analog interferometric modulators.

In some implementations, determining bias voltages as shown in block 530 can include accessing a database that correlates the white point of the display with the bias voltages for the display elements and using the database to determine the corresponding bias voltages for the display elements.

In some other implementations, determining bias voltages as shown in block 530 can include accessing a formula that correlates white point of the display with the bias voltages for the display elements and using the formula to determine the corresponding bias voltages for the display elements. In some implementations, the formula can include a relationship between the red, green and blue voltages. For example, for every 1 volt increase for one display element, the voltages for the other two display elements can be determined (e.g., for every 1 volt the bias voltage for the red display element increases, the bias voltage for the blue display element decreases by about 0.5 volt and the bias voltage for the green display element increases by about 0.25 volt).

Some implementations of method 500 further can include adjusting the white point of the display device by adjusting the bias voltages for the display elements. Adjusting the white point can include using a fixed relationship between the bias voltages for the display elements. Adjusting the white point in some implementations also can include tuning at least one resonant wavelength by adjusting at least one display element. Adjusting at least one display element can include adjusting a distance between the reflective surface and the partially reflective surface of the display element. Some implementations can include holding an image in a static state (e.g., a stationary or still image) while adjusting the white point by adjusting the bias voltages for the display elements. In some implementations of the method 500, the white point can be adjusted to a standardized white point.

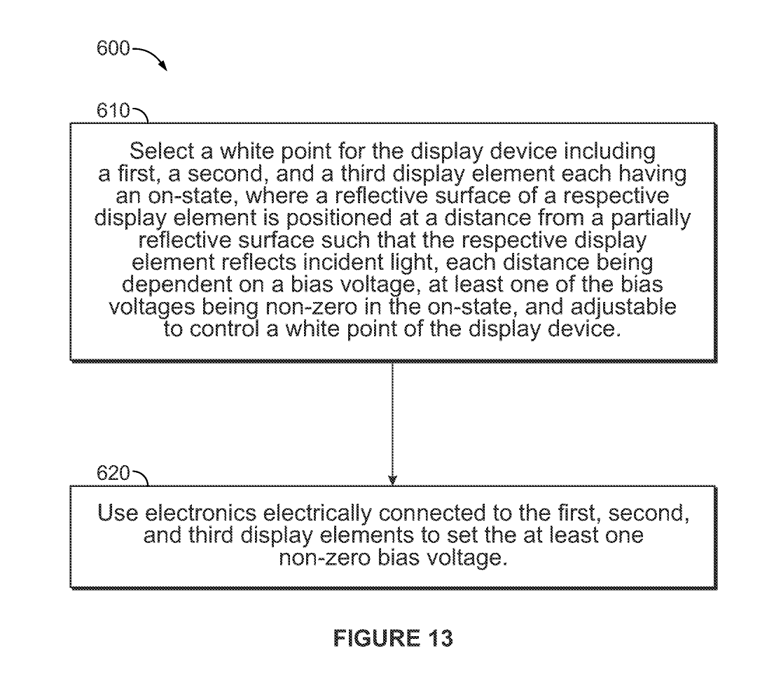

FIG. 13 shows another example method for setting a white point of a display device. The method 600 can include selecting a white point for the display device as shown in block 610. The display device can have first, second, and third display elements. Each display element can have an on-state where a reflective surface of the display element is positioned at a distance from a partially reflective surface of the display element such that the display element reflects incident light. Each distance can be dependent on a bias voltage. At least one of the bias voltages can be non-zero in the on-state, and adjustable to control a white point of the display device. The method 600 of some implementations further can include using electronics electrically connected to the first, second, and third display elements to set the at least one non-zero bias voltage as shown in block 620.

In some implementations, using electronics as shown in block 620 can include accessing a database that correlates white points with the bias voltages and using the database to determine the corresponding bias voltages for the first, second, and third display elements. In some other implementations, using electronics as shown in block 620 can include accessing a formula that correlates white points with the bias voltages and using the formula to determine the corresponding bias voltages for the first, second, and third display elements. The method 600 further can include holding an image in a static state while selecting the desired white point. In some implementations, the first, second, and display elements can include red, green and blue interferometric modulators.

FIGS. 14A and 14B show examples of system block diagrams illustrating a display device 40 that includes a plurality of interferometric modulators. The display device 40 can be, for example, a cellular or mobile telephone. However, the same components of the display device 40 or slight variations thereof also are illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level. In some implementations, the processor 21 can be used to change or adjust the white point of the display device. For example, the processor 21 can use or access a database, LUT, or formula to establish the bias voltages for the display device which correspond to a particular white point and/or color temperature of the display device.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a first display element configured to output light,
a second display element configured to output light,
a third display element configured to output light, and
electronics configured to drive the first, second, and third display elements,
wherein each of the first, second, and third display elements has an on-state wherein a reflective surface is positioned at a distance from a partially reflective surface such that the display element reflects incident light, each distance being dependent on a bias voltage,
wherein at least one of the bias voltages for the first, second, and third display elements is non-zero in the on-state, and adjustable to control a white point of the display device, the electronics electrically connected to the display elements to provide the at least one non-zero bias voltage.

2. The display device of claim 1, wherein the first, second, and third display elements include interferometric modulators.

3. The display device of claim 1, wherein at least two of the bias voltages for the first, second, and third display elements are non-zero in the on-states, and one or more of the at least two bias voltages are adjustable to control the white point of the display device.

4. The display device of claim 1, wherein the bias voltages for the first, second, and third display elements are non-zero in the on-states, and one or more of the bias voltages are adjustable to control the white point of the display device.

5. The display device of claim 4, wherein the bias voltages for the first, second, and third display elements are adjustable to control the white point of the display device.

6. The display device of claim 1, wherein the electronics are configured to access a database that stores information correlating the white point and the bias voltages to establish the bias voltages.

7. The display device of claim 1, wherein the electronics are configured to use a formula that correlates the white point and the bias voltages to establish the bias voltages.

8. The display device of claim 4, further comprising a user interface in communication with the electronics, the electronics being configured to adjust the white point by adjusting the bias voltages for the first, second, and third display elements based on input from the user interface.

9. The display device of claim 8, wherein the electronics are configured to adjust the white point using a fixed relationship between the bias voltages for the first, second, and third display elements.

10. The display device of claim 1, wherein the white point is adjusted by tuning at least one resonant wavelength of an optical resonant cavity defined by the reflective surface and the partially reflective surface of the display element by adjusting the distance between the reflective surface and the partially reflective surface.

11. The display device of claim 1, wherein the first display element includes a red display element configured to output red light when the red display element is in the on-state, the second display element includes a green display element configured to output green light when the green display element is in the on-state, and the third display element includes a blue display element configured to output blue light when the blue display element is in the on-state.

12. The display device of claim 1, wherein the first, second, and third display elements each include white display elements configured to output white light when the display elements are in the on-state.

13. The display device of claim 1, further comprising:
a processor that is configured to communicate with at least one display element, the processor being configured to process image data; and
a memory device that is configured to communicate with the processor.

14. The display device of claim 13, further comprising:
a driver circuit configured to send at least one signal to the at least one display element; and
a controller configured to send at least a portion of the image data to the driver circuit.

15. The display device of claim 13, further comprising:
an image source module configured to send the image data to the processor.

16. The display device of claim 15, wherein the image source module includes at least one of a receiver, transceiver, and transmitter.

17. The display device of claim 13, further comprising:
an input device configured to receive input data and to communicate the input data to the processor.

18. A display device comprising:
a first means for outputting light,
a second means for outputting light,
a third means for outputting light; and
means for driving the first, second, and third light outputting means,
wherein each of the first, second, and third light outputting means has an on-state wherein a means for reflecting light is positioned at a distance from a means for partially reflecting light such that the light outputting means reflects incident light, each distance being dependent on a bias voltage, and
wherein at least one of the bias voltages for the first, second, and third light outputting means is non-zero in the on-state, and adjustable to control a white point of the display device, the driving means electrically connected to the first, second, and third light outputting means to provide the at least one non-zero bias voltage.

19. The display device of claim 18, where the first, second, and third, light outputting means includes first, second, and third interferometric modulators respectively, the driving means includes electronics, the light reflecting means includes a reflective surface or the partial light reflecting means includes a partially reflective surface.

20. The display device of claim 18, wherein the first light outputting means includes a red interferometric modulator configured to output red light, the second light outputting means includes a green interferometric modulator configured to output green light, and the third light outputting means includes a blue interferometric modulator configured to output blue light.

21. The display device of claim 18, wherein the first, second, and third light outputting means includes white interferometric modulators.

22. The display device of claim 18, wherein at least two of the bias voltages for the first, second, and third light outputting means are non-zero in the on-states, and one or more of the at least two bias voltages are adjustable to control the white point of the display device.

23. The display device of claim 18, wherein the bias voltages for the first, second, and third light outputting means are non-zero in the on-states, and one or more of the bias voltages are adjustable to control the white point of the display device.

24. The display device of claim 23, wherein the bias voltages for the first, second, and third light outputting means are adjustable to control the white point of the display device.

25. The display device of claim 18, wherein the driving means is configured to establish the bias voltages based on a correlation between the white point and the bias voltages.

26. The display device of claim 25, wherein the driving means is configured to access a database to establish the bias voltages based on a correlation between the white point and the bias voltages.

27. The display device of claim 25, wherein the driving means is configured to access a formula to establish the bias voltages based on a correlation between the white point and the bias voltages.

28. The display device of claim 25, wherein the driving means includes a processor in communication with a computer-readable storage medium.

29. The display device of claim 18, further including means for receiving a selection of a white point.

30. The display device of claim 29, wherein the receiving means includes a user interface.

31. A method for setting a white point of a display device, the method comprising:
selecting a white point for the display device including a first, a second, and a third display element each having an on-state, wherein a reflective surface of a respective display element is positioned at a distance from a partially reflective surface such that the respective display element reflects incident light, each distance being dependent on a bias voltage, at least one of the bias voltages being non-zero in the on-state, and adjustable to control a white point of the display device; and
using electronics electrically connected to the first, second, and third display elements to set the at least one non-zero bias voltage.

32. The method of claim 31, wherein the first, second, and third display elements include red, green, and blue interferometric modulators, respectively.

33. The method of claim 31, wherein using electronics includes:
accessing a database that stores information correlating white points with the bias voltages, and
using the database to determine the corresponding bias voltages for the first, second, and third display elements.

34. The method of claim 31, wherein using electronics includes:
accessing a formula that correlates white points with bias voltages, and
using the formula to determine the corresponding bias voltages for the first, second, and third display elements.

35. The method of claim 31, further comprising holding an image displayed by the display device in a static state while selecting the white point.

36. A non-transitory tangible computer storage medium having stored thereon instructions that, when executed by a computing system, causes the computing system to perform operations, the operations comprising:
receiving a selection of a white point for a display device,
accessing information that correlates white points with bias voltages for first, second and third display elements of the display device, and
using the information to determine the corresponding bias voltages for the selected white point.

37. The non-transitory tangible computer storage medium of claim 36, wherein receiving the selection of the white point includes receiving the selection via a user interface.

38. The non-transitory tangible computer storage medium of claim 36, wherein accessing information includes accessing a database that stores the information correlating white points with bias voltages.

39. The non-transitory tangible computer storage medium of claim 36, wherein accessing information includes accessing a formula that correlates white points with bias voltages.

40. The non-transitory tangible computer storage medium of claim 39, wherein the formula includes a fixed relationship between the bias voltages for the first, second and third display elements.
